(19) United States
(12) Patent Application Publication
(10) Pub. No.: US 2018/0189850 A1
(43) Pub. Date: Jul. 5, 2018

(54) Method and system for obtaining real-time product procurement proposals

(71) Applicants: Jose Carlos Guedes, Miami Beach, FL (US); Mauricio de Oliveira Guedes, Rio de Janeiro (BR)

(72) Inventors: Jose Carlos Guedes, Miami Beach, FL (US); Mauricio de Oliveira Guedes, Rio de Janeiro (BR)

(21) Appl. No.: 15/850,835

(22) Filed: Dec. 21, 2017

Related U.S. Application Data
(60) Provisional application No. 62/441,632, filed on Jan. 3, 2017.

(51) Int. Cl. G06Q 30/06; G06Q 10/08

(52) U.S. Cl. CPC G06Q 30/0611; G06Q 10/087; G06Q 30/0605; G06Q 30/0603

(57) ABSTRACT

A procurement database is generated by linking a product catalog and a supplier database with a set of product codes. The product catalog contains a first product associated with a first product code. The supplier database comprises at least one supplier of the first product and procurement data for each supplier of the first product. The procurement data comprises a price setting rule and an availability factor with respect to time. A query indicative of at least the first product, a product quantity, and a delivery date is received. Based on the query, the supplier database is searched and a first supplier contained in the supplier database that meets the product quantity of the first product by the delivery date is selected. A proposal for supplying the product quantity of the first product by the delivery date is determined and output.

### CROSS-REFERENCE TO RELATED APPLICATION

This application claims the benefit of U.S. Patent Application No. 62/441,632, filed Jan. 3, 2017. U.S. Patent Application No. 62/441,632 is incorporated herein by reference in its entirety.

### BACKGROUND

The existing digital corporation procurement platforms are intended for individual companies with their own product catalogs, specifications, and suppliers. Updating the registration records depends on the exclusive action of each of the companies that have the records and also on suppliers sending supplier information to each of the companies that have the registration records to keep them updated.

The commercial transactions at the present-day digital platforms area based on bid request processes, takings, analysis of proposals and elaborate commercial negotiations process by process, without relying on the possibility of determining real-time pricing.

### OVERVIEW

In an implementation, a method is provided. The method includes generating, within at least one computer-readable medium, a procurement database by linking a product catalog and a supplier database with at least one set of product codes. The product catalog includes a first product associated with a first product code of the at least one set of product codes. The supplier database includes at least one supplier of the first product and procurement data for each supplier of the first product in the procurement database. The procurement data includes a price setting rule and an availability factor with respect to time. The method also includes receiving, by at least one processor, a query indicative of at least the first product, a product quantity, and a delivery date. The method also includes searching, by the at least one processor, the supplier database based on the query. Furthermore, the method includes selecting, by the at least one processor based on the searching, a first supplier contained in the supplier database that meets the product quantity of the first product by the delivery date. Furthermore still, the method includes determining, by the at least one processor in response to the query, a proposal for supplying the product quantity of the first product by the delivery date. And the method includes outputting, by the at least one processor, the proposal for supplying the product quantity of the first product by the delivery date.

These as well as other aspects and advantages will become apparent to those of ordinary skill in the art by reading the following detailed description, with reference where appropriate to the accompanying drawings. Further, it should be understood that the embodiments described in this overview and elsewhere are intended to be examples only and do not necessarily limit the scope of the invention.

### BRIEF DESCRIPTION OF THE DRAWINGS

Example embodiments are described herein with reference to the drawings.

FIG. 1 is block diagram showing relationships between buyers and sellers.

FIG. 2 is a block diagram showing a platform for buyers and suppliers.

FIG. 3 is a block diagram showing use of a registered data bank.

FIG. 4 is a block diagram showing use of a global supplier data bank.

FIG. 5 is a block diagram illustrating a procurement process.

FIG. 6 is a block diagram illustrating a procurement process.

FIG. 7 shows a table including example data in a product database.

FIG. 8 shows a table including example data in a product database.

FIG. 9 shows a table including example data in a supplier database.

FIG. 10 shows a table including example data in a supplier database.

FIG. 11 shows a system in accordance with an example embodiment.

FIG. 12 is a flowchart depicting operations of a representative method, according to example implementations.

### DETAILED DESCRIPTION

This description describes several example embodiments including, but not limited to, example embodiments that pertain to a platform in which a buyer and sellers exchange information. The example embodiments can be configured as a system on the Internet (platform) that supports a process of acquiring products intended for corporate procurement.

The example embodiments can provide for the sharing on the Internet of product-and-service reference files with technical specifications and international coding shared between users with access to the Internet.

The example embodiments can provide for the creation of a shared supplier reference file on the Internet, linked to the product-and-service catalog, enabling research on the Internet.

The example embodiments can provide for obtaining real-time bids of products and services listed on the catalog, enabling suppliers to provide (e.g., add or modify) price data and availabilities over the course of time referring to the products and services to which they are linked, which provides new dynamics to the corporation procurement activity.

### I. Systems

The system allows a user to search for a product or service for delivery in the future (e.g. twelve months in the future). Current platforms only have information of immediate availability of products or may inform delivery time. The new platform will enable the programming of a purchase of the product at the time the product is required. This feature will allow companies to purchase industrial products for use in its industrial operations. It is important to bear in mind that at the time the buyer performs the search, the product may not be available. In fact, it has to be available at the time of the delivery. As an example, the system may establish a range for the future delivery dates. As an example, the range can comprise a range of one day to five years after the date a request for proposal is submitted to the system.

The platform can be configured to enable the evaluation of the technical and financial capacity of the seller by consulting data of the seller (e.g., financial statements, manufacturing capacity, technical certificates, certifications, legal and fiscal status of the buyer, etc.).

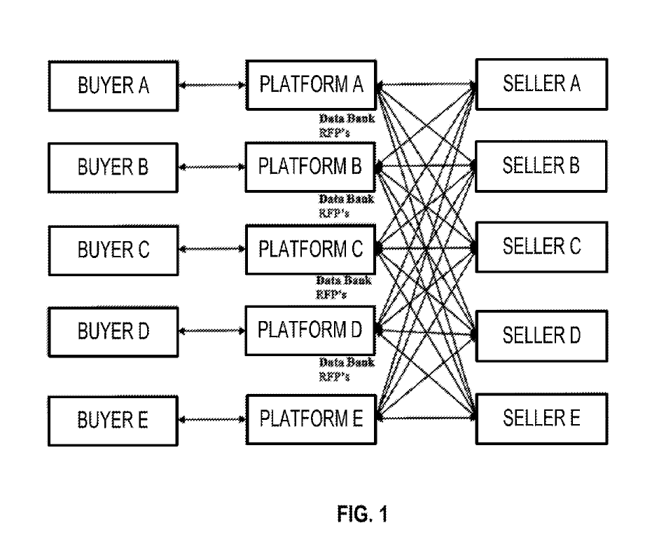

FIG. 1 shows the relationship scheme that is widely practiced by companies having digital platforms of their own, as well as their own databases referring to products and suppliers.

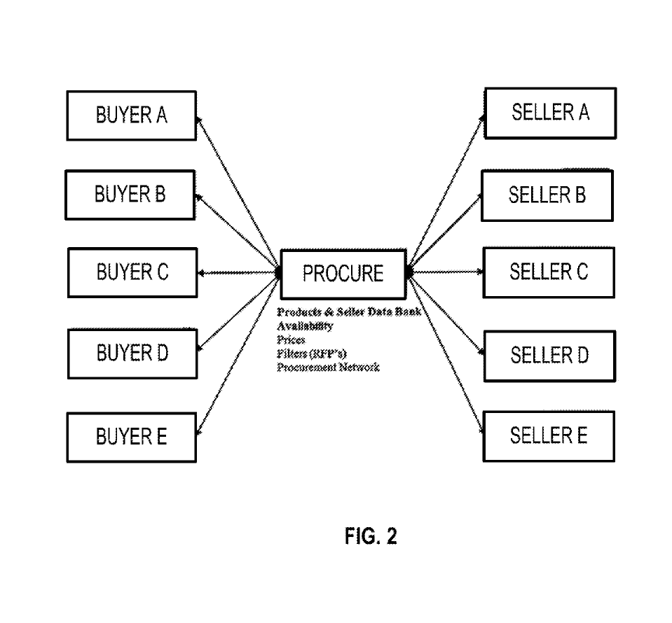

Next, FIG. 2 shows a conceptual scheme in accordance with the example embodiments, where a platform is made available to the users (buyers and suppliers), with a product-and-supplier catalog being kept on the platform, as well as the presentation of prices and availabilities of products in real time, besides providing a relationship environment for the procurement community.

The platform on the Internet will enable the user (buyers) to select an item from the product catalog according to his need, define necessary amounts, as well as desired delivery dates and then search for suppliers that can meet his demand, selecting those to which he wishes to place the order, adjust the commercial conditions (negotiate) or request proposals for specific conditions that are not available in the system standard (issuing Request for Proposal—RFP).

The system combines the philosophy existing on the present-day corporation procurement platforms, which contain product-and-supplier catalogs for in-house use of the company, with the philosophy existing on the platforms available on the Internet for retail or wholesale purchase, which represent in real time the price of products available in stock and also the philosophy existing on the reserve sites (for example, hotels), which present a list of suppliers (hotels) with prices and availability to meet the demand in the required period. In this regard, it is important to take into account that the companies need to acquire products for delivery on future dates, months or years ahead the present date.

The catalog of products available on the system follows the same logics of technical description of products used by the companies that specify these products for purchase, expressing the specifications in parameters so that it will be possible to index the catalog and transform the product into a commodity with a product code, such as the United Nations Standard Products and Services Code® (UNSPSC®) coding.

Each product of the catalog receives a UNSPSC® code.

The users may cooperate by making proposals for alterations in the product reference file, which will be incorporated after analysis by the administrator of the system (inclusion, alteration or exclusion of the item).

The system contains a database of suppliers, and each supplier receives a unique identification code.

The inclusion of the supplier in the database is made by the administrator that will link the registered supplier to at least one item of the product catalog, but may link the suppliers to various discrete items or to a product family. In including the supplier, the administrator will include the basic data, such as: corporate name and location. The administrator functions can be performed by at least one processor of the system.

The data within the supplier database are available in the system to make possible to the user (buyer) to carry out supply assessment using their own criteria. A person of ordinary skill that works in a corporate procurement process can use the data available that he needs to carry out risk assessment (quantitative or qualitative) or to compare with his corporate requirements to check if the supplier fulfill the minimum criteria to supply to his company. The availability of these data organized for a vast number of suppliers in the Internet will make unnecessary for corporations to keep their own supplier database.

The proposal for inclusion may be made by any user and will be approved or rejected by the administrator. As an example, determining the proposal can comprise (i) selecting suppliers linked to the UNSPSC code of the product searched by buyer, (ii) determining which suppliers have product availability for delivered date searched by buyer; and (iii) extracting from each supplier file (for the suppliers which fulfill previous conditions), the price of the product from price rules and general commercial conditions for supplying the product.

As an example, a price rule for a particular type of pipe material ASTM A 106-B, diameter (size) 4 inches, schedule 40, can be comprise factors such as (i) US$1,000.00 per ton up to 100 tons, (ii) US$900.00 per ton above 100 tons, and (iii) add 10% for delivered dates before a particular day, such as Jan. 3, 2017.

As an example, the availability factors for the pipe material ASTM A 106-B, diameter (size) 4 inches, schedule 40, can be comprise system information such as (i) actual stock equals 1,000 tons, (ii) production capacity equals 30 tons per day, (iii) reserved capacity up to a particular day, such as Jan. 7, 2017 equals 1,400 tons, and (iv) the available capacity by a particular day such as Jan. 7, 2017 equals 300 tons (calculated by system). Note that the system can take into account the whole reserved demand, actual stock and future production to check availability, but information on availabilities on daily basis is of supplier responsibility. Suppliers will be responsible for keeping availability updated in the system and have the option to inform a rule or in a discrete way (example: day by day future availability).

The supplier database is formed in such a way that it will contain the information that is typically requested by the companies for inclusion of the supplier in their own databases (legal, technical and financial information).

The supplier will have the option of joining the system by contract. The supplier that has joined by contract will receive an interface for administration of his registered data, and the use of the product reserve interface for administration of the available capacity can be made compulsory (if the supplier opts for making the price available on the System). In this way, any product reserve, even if it is made out of the system, will be incorporated for control of the available capacity of the product over the course of time. In other words, the supplier will upload the data referring to availability of products and prices over the course of time (calendar year) according to their available and political price capacity.

The example embodiments allow for the supplier to join the system by uploading price and availability data. However, for those who do so, it can be made compulsory to use the reserve interface, so that the user (buyers), upon making the research and reserve of the product, will be receiving consistent information.

For the other registered suppliers who have not jointed by contract, the system may provide only basic data regarding the non-registered suppliers for mere reference of the users.

The suppliers that join the system are allowed to establish a level of opening information contained in the reference file and even of the information on prices and availability, and they may make them available either for all or for a part of the users, and in a differentiated manner for each user.

The users of the system can be provided with the ability to search for suppliers by using a UNSPSC® code, by the product name, specific parameters of the product (size, material, etc.), by the availability in the period required by the availability in the required amount, by the supplier name, by the region (location of the supplier), or by the supplier type (example, maker, distributor, etc.).

As a result of the search, the system presents a list of suppliers (e.g., one or more suppliers) in an organized manner, listing those that meet the specified demand, with the available prices and filter options, and ordering the list to be chosen by the user (example, best prices, only those that meet the demand, only those of a given region, only those that present prices, etc.).

The user may search for the options of transactions for product reserve, product purchase or emission of RFP (request for proposals) with rules and standards defined by the user or negotiations with selected suppliers (price adjustments and contract conditions).

Each user will have an individualized profile, and will have the option of joining for access to options of transactions (profiles of joined suppliers and of buyers).

The platform can enable users to search for suppliers of products listed and classified according to UNSPSC® coding, catalogs on the platform. It enables the suppliers to upload price and availability data for cataloged products, so that the users can obtain a list of suppliers and bids in real time for their needs, with regard to both prices and availability for delivery at the requested time. It further enables the suppliers to feed the supplier database with data that are typically requested by the clients in their corporation supplier reference files, such as: financial statements, articles of incorporation, organization charts, technical written opinions, manufacturing capacity, etc. It enables the users to add specifications of products according to their own corporation guidelines or production lines in a collaborative manner (always referring to a product classification (such as the UNSPSC® classification)) and also to include or link suppliers to the products existing on the catalog. Closing commercial transactions or product reserves by buyers and the confirmations and acceptances of the transactions and product reserves by the sellers may be made directly in the platform environment. The platform provides facilities for communication between users (chat, meeting rooms, discussion forums, functioning as a relationship environment for the registered users.

As an example, the system can determine real-time proposals within one minute and then delivered to the buyer in the amount of time required to deliver the proposal over the communication network.

In order for the companies to make acquisitions of products necessary to keep their processes, typically each company builds a supplier database and keeps it updated, which contains information that enables the company to identify which products the companies can supply, their technical capacity to assist the company and its juridical, tax, economic and financial situation, so that it can be possible to evaluate, at any moment, the capacity and risk of meeting the demands that become necessary. This implies a continuous effort on the part of the supply areas of the companies and on the part of the commercial areas of the suppliers.

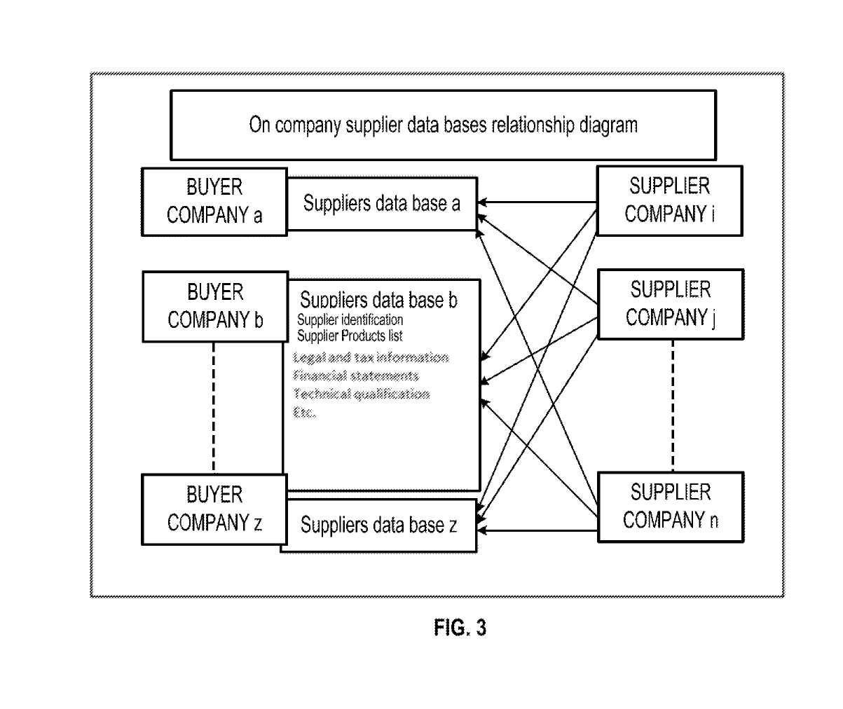

In order for the supplier to have the opportunity of possibly being consulted in an acquisition process, it is necessary that the supplier is included into the registration of companies that potentially have interest in its line of products. These are potential buyers that are distributed around the world, implying a need for commercial contact, sending and keeping updated information for a huge number of companies around the world, which in practice causes its supply possibility to be limited to the size of the possible commercial and operational effort. In the same way, the companies limit their market consultation to the group of companies that is part of their supplier database, and it is not possible to the companies to exhaust the analysis of the company universe around the world that supply a determined product, that is, the companies do not know whether they will have the best possible offers on the market, since their consultation universe is limited to the companies that are registered in their data bank. See FIG. 3.

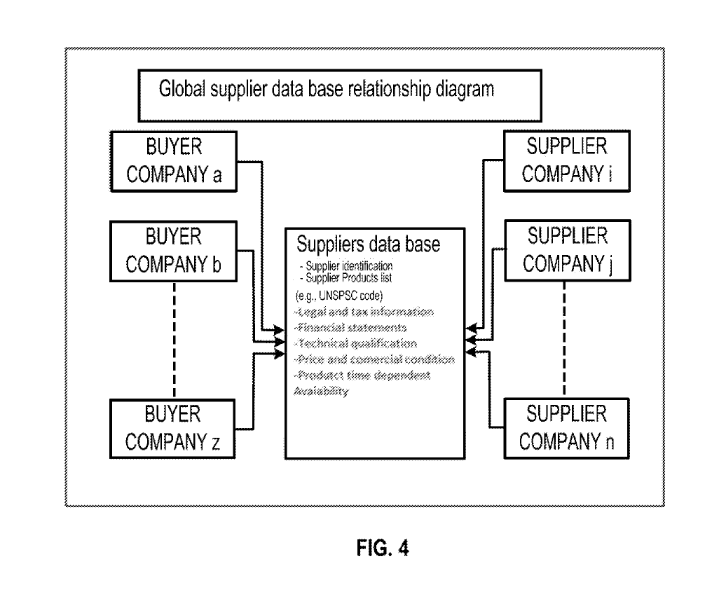

The example embodiments comprise a global supplier database. The suppliers do not have to send and keep updated a number of databases belonging to the buyer companies, but rather only one global database in the communication network. The buyer companies will not have to keep their supplier databases, since the information will be available in the global database, reducing immensely both the necessary commercial effort of the supplying companies and that of the buyer companies in this process (see FIG. 4). In this global database, the suppliers might further keep their price polices (commercial conditions for supplying their products, depending on the amounts in demand, desired delivery dates, etc.) and their available capacity to meet the demand in the course of time.

It is important to bear in mind that the corporate procurements are made, as a rule, for delivery on future dates, distant from the market consultation date (months or even years ahead), and so it becomes necessary to know not only the immediate possibility of stock of the product, but rather the availability for delivery on the desired date.

Coupled to the creation of the global supplier database, a product database will be created, with parametrized technical descriptions and coded according to a product code (such as the UNSPSC®, the Common Procurement Vocabulary (VCP) developed by the European Union, the Global Trade Item Number (GTIN) standard by GS1 US, Inc., or a different product code), so that it may be possible to link the product database (and products defined in the database) to the supplier database through the product code. A user can search for the products contained in the product database via a computer processor programmed to search the product database by description of the product or by its code.

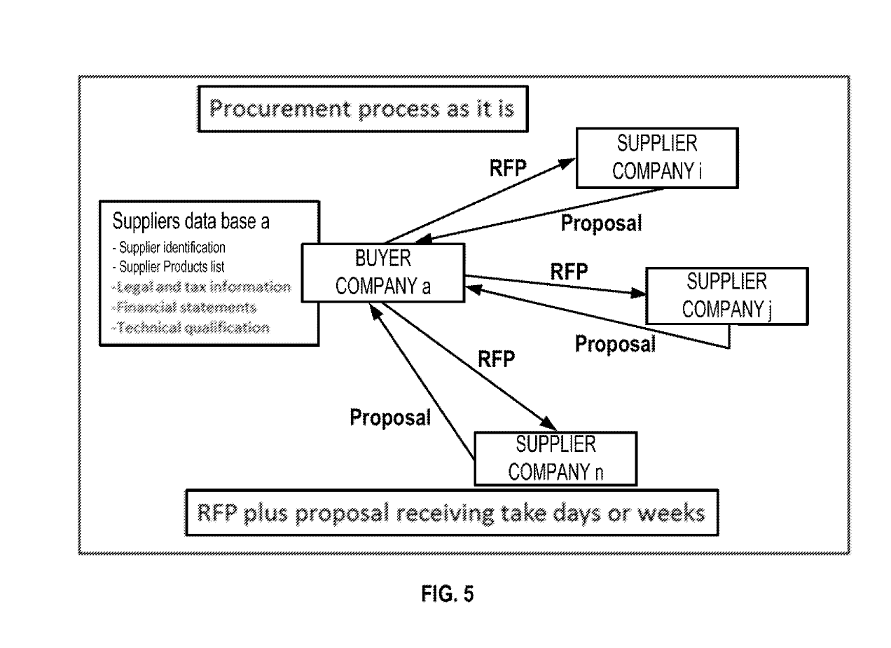

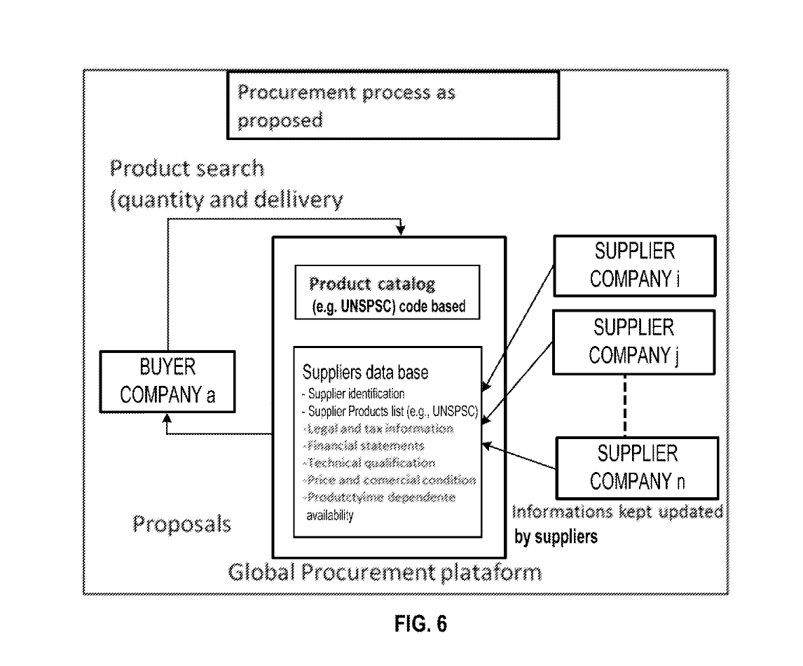

This concept of linkage of the product database to the supplier database, which not only rely on the registered information of the suppliers, but also on price-setting of products and availability in the course of time, will enable one to evolve from the market consultation model which we have today, where the buyer sends to a list of potential suppliers a demand with amounts and desired delivery dates of a determined product (Request for proposal) and await during days or even weeks to receive the commercial proposals for a given model, where the buyer inserts into the procurement platform his demand parameters (product, amounts and desired delivery dates), the system selects the suppliers that meet the demand in the database and prepares the commercial proposals instantaneously, offering to the user options of filters and organization of the proposals in a much wider universe of consultation to suppliers than that which is possible in the present process with less consultation effort and higher response velocity. This model will become viable for the buyer companies to test on the market alternatives of proposal requirements, aiming at amounts and delivery dates until they will find optimum parameters that can meet the business conditions better (since today the proposals take days or weeks to be obtained, it is not practical to make many iterations to test the parameters of the RFP). See FIG. 5 and FIG. 6, which illustrate this process in a simplified manner.

What enables the platform to present proposals in real time is the linkage of the supplier database that contains price-setting criteria of the products and the availability in the course of time, linking to the product database, through standardized coding of products (UNSPSC® code) and, since the buyer has at its disposal the supplier database with updated registered information, the supplier will have the opportunity to evaluate the risk associated with each supply proposal.

In summary, the idea proposes a new product-procurement process by companies and a system available on the World Wide Web, which gives support to this process.

The example embodiments provide for creating and using a global registration of products with the coding UNSPSC® or another product coding scheme, linked to a global supplier database for products contained in the product catalog, the supplier database having the registered information, price policy (prices of the products according to the size of the demand and with the desired delivery dates) and information on availability of the product in the course of time. The example embodiment can provide a link between the two databases (product catalog and supplier database), coupled to keeping information updated in the supplier database of the price information and availability of products in the course of time which will enable one to mount the proposal in an automatic and immediate manner. The automatic link can occur when the UNSPSC product code from product catalog matches with one of UNSPSC code from a list of codes that is included in the supplier information on the supplier's database.

As an example, the product code can contain a parameterized technical description of each product. For example, a particular pipe can be described in the product database with the following parameters: (i) product=pipe, (ii) material=ASTM A 106-B, (iii) diameter (size)=four inches, and (iv) thickness=schedule 40. As another example, a particular valve can be described in the product database with the following parameters: (i) product=valve, (ii) design standard=ANSI B 16.34, (iii) valve type=gate. (iv) body material=ASTM A 105, (v) interior material=ANSI 304, (vi) nominal size=four inches, (vii) pressure rating=600 lbs., (viii) face-to-face=ANSI B 16.10, and (ix) end connection=ANSI B 16.5.

The example embodiments provide for making available in the system information on prices and amounts available of products for delivery on future dates planned by the buyers.

None of the existing platforms, be it focused on services or products, contains linkage of the products or services offered with supplier database so as to enable the user to evaluate whether the supplier has technical, productive capacity, juridical and tax regularity or financial capacity to meet the required demand (evaluation of risk of the supplier).

The use of the UNSPSC® code system will enable one to link products and suppliers in bi-reciprocal, enabling a wide range of options of search associating the information contained in the product catalog with the supplier database.

The system will have various other functionalities, considering the complete product procurement process, such as availability of contract standard minutes, options of adjustments of commercial conditions between buyer and seller from the offers generated automatically in the system, as well as the adjustment of the contract conditions, options of reserve of products within the time offered by the seller for keeping proposals in the system.

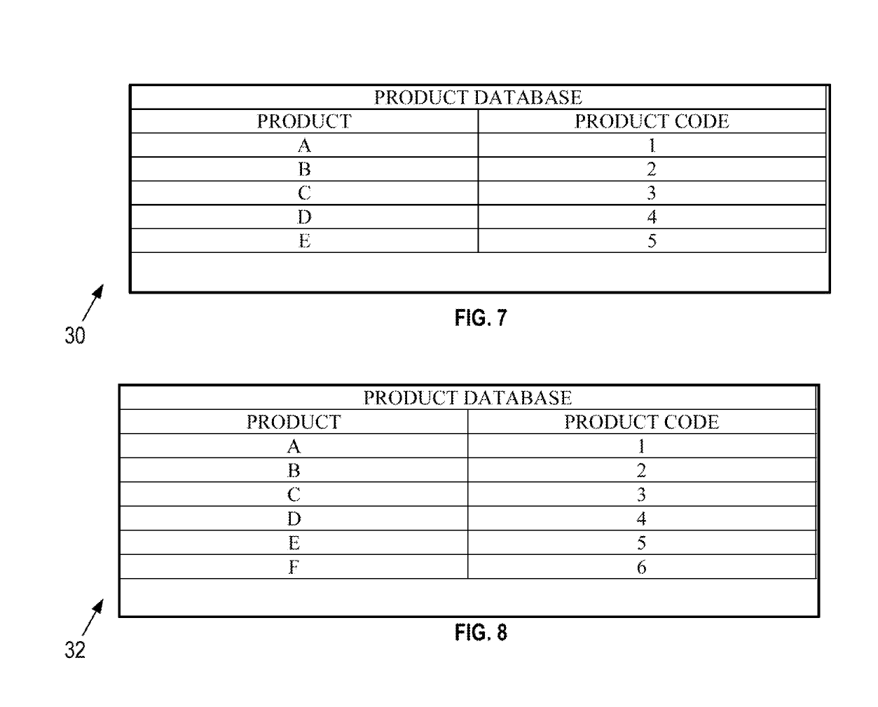

Next, FIG. 7 shows a table 30 including an example of data within the product database. As shown in FIG. 7, the product database includes a name or identifier for each product (e.g., A, B, C, D, and E) and a product code (e.g., 1, 2, 3, 4, and 5) associated with each product in the product database. A person skilled in the art will understand that the product code associated with each product can comprise a UNSPSC® code, and the product name or identifier can comprise a description of the product (e.g., ink pen refill with blue ink). Other examples of the product name or product codes within the product database are also possible.

Next, FIG. 8 shows a table 32 including an example of data within the product database after the system has added a new product to the product database. In particular, a new product identified as product “F” has been added to the product database and associated with a new product code “6.”

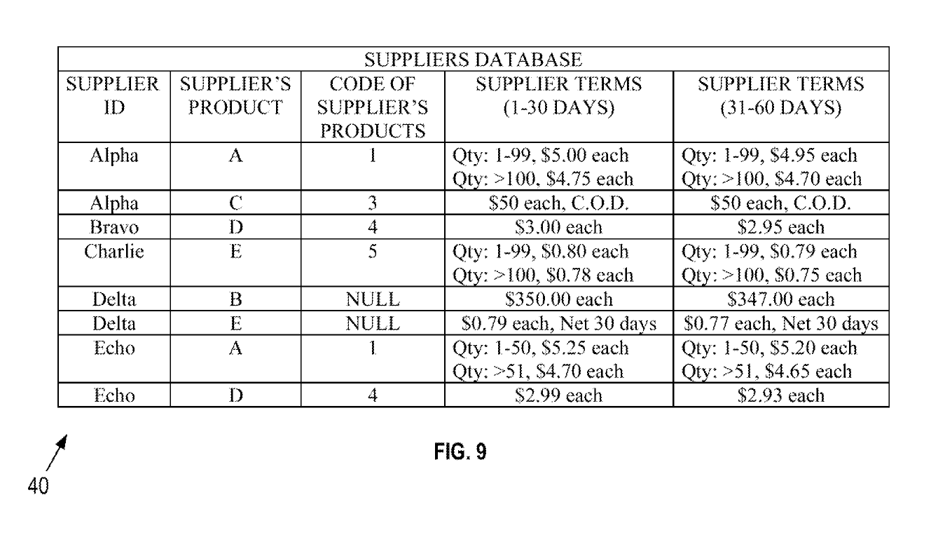

Next, FIG. 9 shows a table 40 including an example of data within the supplier database. As shown in FIG. 9, the supplier database can comprise a supplier identifier for each supplier. Each supplier can include data with respect to one or more products. For example, the suppliers referred to as “Bravo” and “Charlie” each have data for a single product within the supplier database, whereas the suppliers referred to as “Alpha,” “Delta,” and “Echo” each have data for two products within the supplier database. A person skilled in the art will understand that one or more suppliers can have data for more than two products within the supplier database.

FIG. 9 further shows that the data regarding each supplier can comprise a description of the supplier's product (e.g., product identifier A, B, C, D, and E), the code assigned to at least some of the supplier's products (e.g., product codes 1, 3, 4, and 5), and terms for the supplier supplying the product. As an example, the supplier terms can comprise price terms (e.g., price terms based on the desired delivery date such as 1-30 days or 31-60 days) and payment terms (e.g., cash on delivery (C.O.D.) and net payment due in 30 days (Net 30 days). Other terms applicable for developing a proposal for a buyer can be included within the supplier database. Examples of these other terms are discussed above and are shown in other figures of this application.

FIG. 9 also shows that the supplier database can exist in a state in which various supplier data is not contained in the supplier database. For example, the supplier referred to as Delta may have provided its data without the product codes for their products referred to as product B and product E. This is represented by the word “NULL” in the table 40.

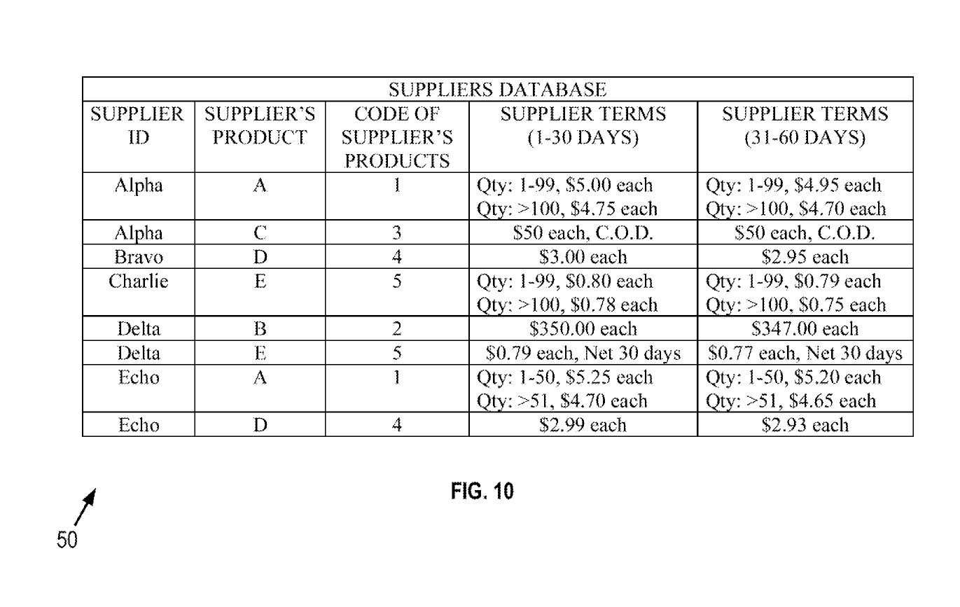

The system can determine that the supplier database does not include a product code for a supplier's product and refer to the product database to determine the product code for the supplier's product and add the product code into the supplier database. FIG. 10 shows a table 50 including an example of data within the supplier database after the system has added the determined product codes for the supplier Delta's products B and E.

A person skilled in the art will understand that the supplier's product can comprise a service provided by the supplier and the code of supplier's product can represent the service provided by the supplier.

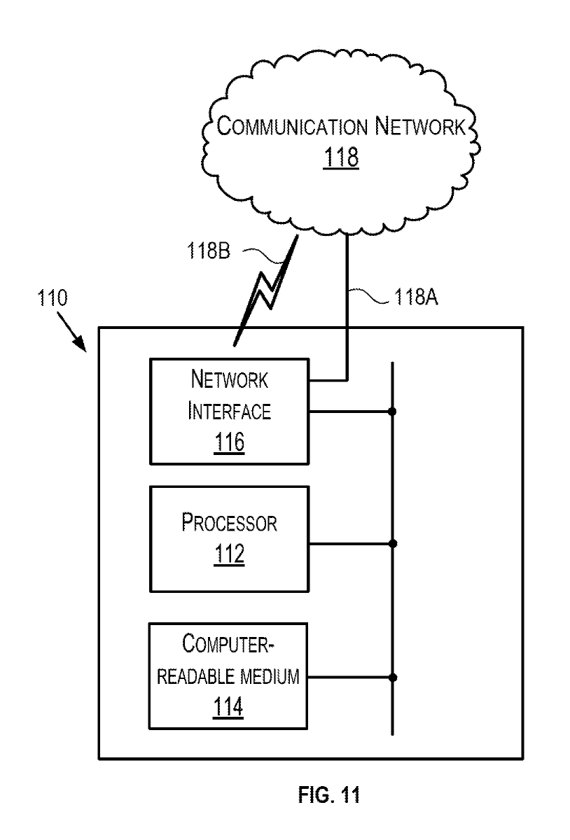

FIG. 11 shows a system 110 (for example, a computing device) in accordance with the example embodiments. The system 110 that carries out the example embodiments can comprise a processor 112, a computer-readable medium (CRM) 114, and a network interface 116 configured to transmit and receive data over a communication network 118 (e.g., a wide area network (WAN) such as the Internet). The data can comprise data to be added to the product database or the supplier database, data for modifying the product database or the supplier database, a request (e.g., a request for a proposal to supply a product quantity of a particular product by a particular delivery date), and a response (e.g., a response comprising a response to a request for a proposal).

A processor can comprise one or more general purpose processors (e.g., INTEL® single core microprocessors or INTEL® multicore microprocessors) or one or more special purpose processors (e.g., digital signal processors or graphics processors). Additionally or alternatively, a described processor may include an application specific integrated circuit (ASIC). A described processor can be configured to execute computer-readable program instructions (CRPI) stored in a CRM. A described processor may be configured to execute hard-coded functionality in addition to or as an alternative to software-coded functionality (e.g., via CRPI).

A computer-readable medium can comprise a non-transitory computer-readable medium, a transitory computer-readable medium, or both a non-transitory computer-readable medium and a transitory computer-readable medium. In one respect, a non-transitory computer-readable medium may be integrated in whole or in part with a processor. In another respect, a non-transitory computer-readable medium, or a portion thereof, may be separate and distinct from a processor.

A non-transitory computer-readable medium may include, for example, a volatile or non-volatile storage component, such as an optical, magnetic, organic or other memory or disc storage. Additionally or alternatively, a non-transitory computer-readable medium may include, for example, a random-access memory (RAM), a read-only memory (ROM), a programmable read-only memory (PROM), an erasable programmable read-only memory (EPROM), an electrically erasable programmable read-only memory (EEPROM), a compact disk read-only memory (CD-ROM), or another memory device that is configured to provide data or CRPI to a processor.

A transitory computer-readable medium may include, for example, CRPI provided over a communication network. The communication network can comprise a digital or analog communication network. The communication network can comprise a wired communication network 118A or a wireless communication network 118B.

A computer-readable medium may be referred to by other terms such as a “computer-readable storage medium,” a “data storage device,” a “memory device,” a “memory,” or a “computer-readable database.” Any of those alternative terms may be preceded with the prefix “transitory” or “non-transitory.”

### II. Example Operation

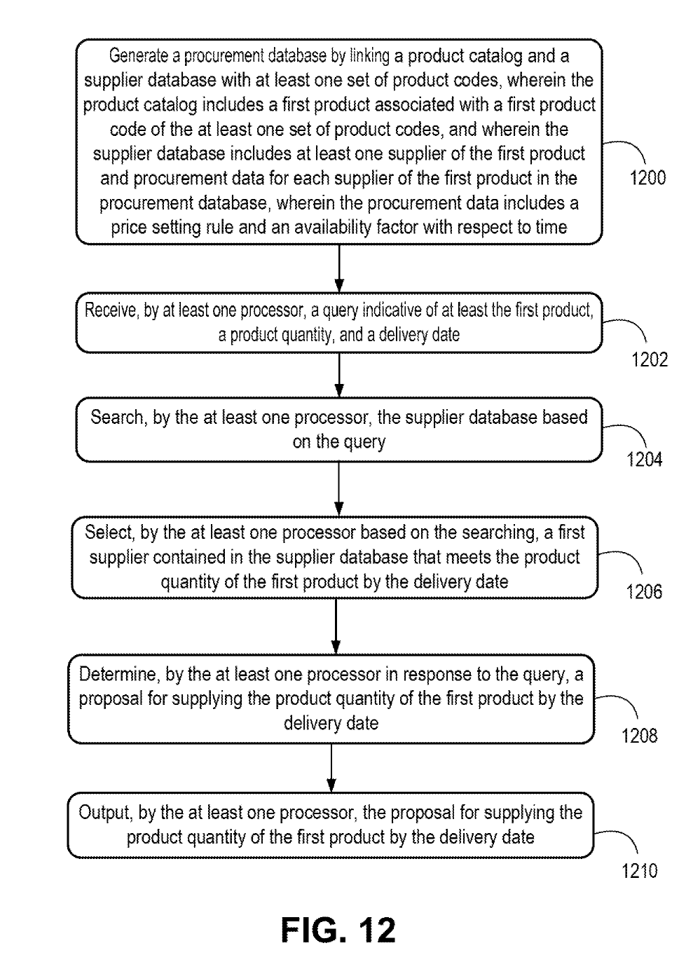

FIG. 12 is a flowchart depicting operations of a representative method for generating a procurement database.

At block 1200, the method includes generating, within at least one computer-readable medium, a procurement database by linking a product catalog and a supplier database with at least one set of product codes, wherein the product catalog includes a first product associated with a first product code of the at least one set of product codes, and wherein the supplier database includes at least one supplier of the first product and procurement data for each supplier of the first product in the procurement database, wherein the procurement data includes a price setting rule and an availability factor with respect to time.

At block 1202, the method includes receiving, by at least one processor, a query indicative of at least the first product, a product quantity, and a delivery date.

At block 1204, the method includes searching, by the at least one processor, the supplier database based on the query.

At block 1206, the method includes selecting, by the at least one processor based on the searching, a first supplier contained in the supplier database that meets the product quantity of the first product by the delivery date.

At block 1208, the method includes determining, by the at least one processor in response to the query, a proposal for supplying the product quantity of the first product by the delivery date.

At block 1210, the method includes outputting, by the at least one processor, the proposal for supplying the product quantity of the first product by the delivery date.

In some implementations, the at least one set of product codes comprises multiple product codes according to a United Nations Standard Products and Services Code (UNSPSC®). Furthermore, the product catalog further can contain a parameterized technical description of the first product, and the query can indicate the product by a technical description of the first product and/or a UNSPSC® code associated with the first product.

In some implementations, the first product comprises a service.

In some implementations, the product catalog contains multiple products associated with a respective code of the at least one set of product codes.

In some implementations, receiving the query comprises receiving the query on a first date. As an example, the delivery date can fall within a range of one day to five years after the first date. As another example, the delivery date can fall on the first date.

In some implementations, the at least one supplier of the supplier database comprises multiple competing suppliers of the first product.

In some implementations, the method further includes: (i) receiving, by the at least one processor for each of the multiple competing suppliers, a respective price setting rule and a respective availability factor with respect to time, and (ii) adding, by the at least one processor for each of the multiple competing suppliers to the procurement database, the respective price setting rule and the respective availability factor with respect to time.

In some implementations, receiving the query comprises the at least one processor receiving a first network communication carried by a wide area network, and outputting the proposal comprises the at least one processor transmitting a second network communication onto the wide area network.

In some implementations, the method further includes: (i) receiving, by the at least one processor, modified procurement data for the first supplier, and (ii) modifying or replacing, within the at least one computer-readable medium, prior procurement data stored in the procurement database for the first supplier with the modified procurement data.

In some implementations, outputting the proposal occurs within one minute of the at least one processor receiving the query.

In some implementations, the procurement data for each supplier comprises a technical qualification of the supplier, a financial statement of the supplier, legal and tax information of the supplier, and/or juridical information pertaining to the supplier.

In some implementations, the proposal comprises a first proposal, and the method further includes receiving, by the at least one processor, at least one filter criterion after outputting an earlier proposal for supplying the product quantity of the first product by the delivery date. Furthermore, the query can also be indicative of the at least one filter criterion.

In some implementations, linking the product catalog and the supplier database comprises (i) determining the supplier database does not comprise a product code of the set of product codes for a product previously added or being added to the supplier database, and (ii) adding into the supplier database for the product previously added or being added to the supplier database a particular product code associated with the product previously added or being added to the supplier database. Furthermore, the set of product codes can include the particular product code.

In some implementations, linking the product catalog and the supplier database comprises providing a product code of the set of product codes defined for a particular product or a particular family of products into the supplier database for a supplier that supplies a product that matches the particular product or that supplies a family of products that matches the particular family of products.

In some implementations, determining the proposal can include determining from the supplier database a set of suppliers. The supplier database can indicate each supplier of the set of suppliers supplies the first product associated with the first product code. Furthermore, the supplier database can indicate each supplier of the set of suppliers can supply the product quantity of the first product by the delivery date. Furthermore still, determining the proposal can include determining for each supplier of the set of supplier a cost of supplying the product quantity of the first product by the delivery date.

In some implementations, the supplier database can comprise data indicating a commercial condition for at least one supplier of the set of suppliers to supply the first product. Determining the proposal can include determining the commercial condition for at least one supplier of the set of suppliers to supply the first product. Furthermore, the method can include aggregating the commercial condition for at least one supplier of the set of suppliers to supply the first product into the proposal.

In some implementations, a computer-readable medium storing instructions that when executed by at least one processor of a computing device cause the computing device to perform acts in accordance with the method(s) discussed above. Furthermore, a computing device can include that computer-readable medium, a processor, and a network transceiver.

### III. Additional Features

A. Global Electronic Corporate Marketplace

Corporate procurement is based on a direct relationship between client/supplier and processes not connected and not necessarily consistent among them. Multiple and incomplete supplier databases are kept on corporate procurement areas. Price and availability of goods are requested and prepared for many individual bids and they do not exhaust offers available in the market. Price and availability information are available in the suppliers' databases.

Convergence—The central idea is to capitalize corporate procurement convergence opportunities, organize products and suppliers' information, and make such information available globally.

Corporate procurement process can include building and keeping updated a supplier database. Corporate procurement areas in the companies keep their supplier database with product list, technical qualifications, production capacity, performance indicators, financial data, legal and tax situation. These corporate procurement areas allow one (internal user) to search for suppliers and to request information. Information in the corporate procurement area is intended to be kept up to date. Suppliers marketing areas can make a best effort to be included on a potential client's database to demonstrate the supplier's capability to fulfill potential requests. The client can eventually buy the supplier's products. Potential clients are identified and provided information for the clients' databases. Information in the clients' databases is kept up to date. Moreover, buyers and sellers are spread all over the world and budget and operational capacity of the companies limit the extent of the existing corporate databases. The limitations may arise from the efforts buyers and seller exert to (i) identify suppliers that fit their needs or potential clients, and (ii) convince the supplier or potential clients to provide and keep updated information on their databases, for companies located throughout the world. These limitations can impact procurement processes by not covering a significant portion of the existing offers in the global market and do not contribute to transparency.

A supplier database can be a global supplier database. A supplier database can be available online, for example, on a computer network referred to as the World Wide Web and/or the internet. The supplier database can contain common information that a corporation requires from its suppliers. The supplier database can be reviewed and updated by the suppliers based on a need or requirement of a buyer, purchaser, and/or potential buyer or purchaser. The supplier database allows a supplier to have to update information in a single database, rather than providing separate updates to multiple databases of several purchasers or potential purchasers. Moreover, the supplier can choose different levels of disclosure to users of the supplier database. Furthermore, the supplier database can reduce the need for purchasers to keep their own supplier database since the global supplier database can contain the information desired by the purchaser over the internet.

In the implementations, the global supplier database can be much more effective and less resource demanding to the commercial and prospective effort from buyers and sellers. A global supplier database can provide an option to the sellers loading information into the database based on their price rules and time dependent availability of their products. Corporations may take actions to buy material to planned delivered dates, ahead in time, far from the date of the transaction(s) (for example, months or years ahead of time).

In the implementations, the product database can include a UNSPSC coding system. Along with the supplier database, a products database contains technical parameterized product specifications coded in accordance to the UNSPSC coding system, in such a way that is possible to link the product database to the supplier database (through UNSPSC code). A user can search the product database for products, for example, by the UNSPSC code and/or a product specification.

In some implementations, real time proposals are available. The link between the supplier database and the product database(s) is not limited to corporate information on suppliers. For example the link between those databases can provide price and time dependent availability of the products. This can allow an evolution where the buyer will inform the request parameters, like product specification, quantities and planned delivery dates and will receive in real time from the system, a suppliers list that fit the request from the database query with the suppliers' commercial proposals automatically built. Proposals list filters and organizing options will be available to the users, since the search can be conducted to proposals set much more vast than today. The real time search in comparison to the existing procedure of RFP's allow the buyers to run as many requests as they wish, varying quantities, specifications and delivery dates in order to find which set of parameters best fit their business goals (given today's proposals term of days or weeks to be available to the buyers, this kind of test to find optimum set of RFP's parameters is not possible to be carried out). Linking the supplier database, containing information such as price rules and time dependent availability, to the products database through UNSPSC coding system allows real time proposals to be possible. The system will allow a buyer to have corporate supplier information (financial statements, performance indicators, legal and taxes information, etc.) available, such that the buyer will can carry out proposals risk assessment using their own methodology.

B. Convergence Drives

The implementations can (i) significantly improve procurement process efficiency and transparency, (ii) lead to developing market intelligence, (iii) lead to additional trading opportunities, (iv) lead to better management of banking activities, such as credit, warranties, etc., (v) stimulate service opportunities related to the procurement process, (vi) provide a better environment for outsourcing, and (vii) improve efforts in supplier certification, market assessment, design and inspections.

C. Example Products

As an example, the supplier database can include information for products, such as (i) pipes and fittings, (ii) valves, (iii) cables, electrical or instrumentation, (iv) electrical equipment, (v) instruments, (vi) steel plates, (vii) coatings, and/or (viii) pumps.

D. Example Markets

Use of the supplier database could be targeted to a material supplier, such as a corporate material supplier, a service supplier, such as a corporate service supplier, a procurement department, such as a corporate procurement department, and/or a trader. Revenue though use of the supplier database can occur as a result of P4P, a marketing display, an added value service, and/or a commission.

E. Conclusions

The example embodiments provide for a new procurement process that can be performed for corporations, supported by a system available in the internet. Linking a supplier database to a product database is a key point, which alongside to an updated supplier database containing pricing rules and time dependent availability allows proposals to be built automatically and in real time.

The corporate procurement process can be highly relevant to availability in the internet the pricing rules and products availability to planned delivered dates. The example system can combine the existing electronic corporate procurement platforms philosophy to the existing ecommerce site's philosophy and also the booking site's idea (ex. Hotels). In this respect it is important to take into consideration the need of corporations to request proposals and contract supply for their needs for delivered planned dates (months or years ahead from RFP's).

Linking databases through coding system (e.g. UNSPSC) can allow a vast spectrum of search from products and suppliers' database. Multiple functionalities like: drafting contract, commercial adjusting tool based on the automatically generated proposals, product reserve options, etc.) can be available to the users.

No existing platform is directed to services or products includes a link between products offered and suppliers' database with enough information that would make possible for the user to carry out an assessment to evaluate supplier capacity (technical, legal, financial) to fulfill demand request within adequate risk. Furthermore, no existing platform is directed to products market includes a feature that allows user (buyer) to search offers that fulfill that need future planned delivery dates.

Once the platform is being used by procurement community, it is expected to stimulate commercial relationship between buyers and sellers through the site environment, amplifying the commercial reach from buyers and sellers (Procurement Network). A community of users can use additional features such as (i) profile disclosure, (ii) chats, (iii) forum, and/or (iv) meeting rooms. A great number of business opportunities can emerge from the use of the platform.

It is hard to accept that big procurement and commercial areas of big corporations is still working with door to door salesmen logics within the world living globalized and connected, depending on personal meetings and folders delivery to reach opportunities to compete. Even if is the case of the access through electronic corporate platforms, the business existing model is still the “door to door” logics. The present disclosure describes implementations that overcome the existing limitations.

What is claimed is:

1. A method comprising:
generating, within at least one computer-readable medium, a procurement database by linking a product catalog and a supplier database with at least one set of product codes, wherein the product catalog includes a first product associated with a first product code of the at least one set of product codes, and wherein the supplier database includes at least one supplier of the first product and procurement data for each supplier of the first product in the procurement database, wherein the procurement data includes a price setting rule and an availability factor with respect to time;
receiving, by at least one processor, a query indicative of at least the first product, a product quantity, and a delivery date;
searching, by the at least one processor, the supplier database based on the query;
selecting, by the at least one processor based on the searching, a first supplier contained in the supplier database that meets the product quantity of the first product by the delivery date;
determining, by the at least one processor in response to the query, a proposal for supplying the product quantity of the first product by the delivery date; and
outputting, by the at least one processor, the proposal for supplying the product quantity of the first product by the delivery date.

2. The method of claim 1, wherein the at least one set of product codes comprises multiple product codes according to an international code system such as United Nations Standard Products and Services Code (UNSPSC®).

3. The method of claim 2,
wherein the product catalog further contains a parameterized technical description of the first product, and
wherein the query indicates the product by a technical description of the first product and/or an international code system such as UNSPSC® code associated with the first product.

4. The method of claim 1, wherein the first product comprises a service.

5. The method of claim 1, wherein the product catalog contains multiple products associated with a respective code of the at least one set of product codes.

6. The method of claim 1,
wherein receiving the query comprises receiving the query on a first date, and
wherein the delivery date falls within a range of one day to five years after the first date.

7. The method of claim 1,
wherein receiving the query comprises receiving the query on a first date, and
wherein the delivery date falls on the first date.

8. The method of claim 1,
wherein the at least one supplier of the supplier database comprises multiple competing suppliers of the first product.

9. The method of claim 8, further comprising:
receiving, by the at least one processor for each of the multiple competing suppliers, a respective price setting rule and a respective availability factor with respect to time; and
adding, by the at least one processor for each of the multiple competing suppliers to the procurement database, the respective price setting rule and the respective availability factor with respect to time.

10. The method of claim 1,
wherein receiving the query comprises the at least one processor receiving a first network communication carried by a wide area network, and
wherein outputting the proposal comprises the at least one processor transmitting a second network communication onto the wide area network.

11. The method of claim 1, further comprising:
receiving, by the at least one processor, modified procurement data for the first supplier; and
modifying or replacing, within the at least one computer-readable medium, prior procurement data stored in the procurement database for the first supplier with the modified procurement data.

12. The method of claim 1, wherein outputting the proposal occurs within one minute of the at least one processor receiving the query.

13. The method claim 1, wherein the procurement data for each supplier comprises a technical qualification of the supplier, a financial statement of the supplier, legal and tax information of the supplier, and/or juridical information pertaining to the supplier.

14. The method of claim 1,
wherein the proposal comprises a first proposal,
the method further comprising:
receiving, by the at least one processor, at least one filter criterion after outputting an earlier proposal for supplying the product quantity of the first product by the delivery date,
wherein the query is further indicative of the at least one filter criterion.

15. The method of claim 1,
wherein linking the product catalog and the supplier database comprises (i) determining the supplier database does not comprise a product code of the set of product codes for a product previously added or being added to the supplier database, and (ii) adding into the supplier database for the product previously added or being added to the supplier database a particular product code associated with the product previously added or being added to the supplier database, and
wherein the set of product codes comprises the particular product code.

16. The method of claim 1,
wherein linking the product catalog and the supplier database comprises providing a product code of the set of product codes defined for a particular product or a particular family of products into the supplier database for a supplier that supplies a product that matches the particular product or that supplies a family of products that matches the particular family of products.

17. The method of claim 1,
wherein determining the proposal comprises determining from the supplier database a set of suppliers,
wherein the supplier database indicates each supplier of the set of suppliers supplies the first product associated with the first product code,
wherein the supplier database indicates each supplier of the set of suppliers can supply the product quantity of the first product by the delivery date, and
wherein determining the proposal comprises determining for each supplier of the set of supplier a cost of supplying the product quantity of the first product by the delivery date.

18. The method of claim 17,
wherein the supplier database comprises data indicating a commercial condition for at least one supplier of the set of suppliers to supply the first product;
wherein determining the proposal comprises determining the commercial condition for at least one supplier of the set of suppliers to supply the first product, and
aggregating the commercial condition for at least one supplier of the set of suppliers to supply the first product into the proposal.

19. A computer-readable medium storing instructions that when executed by at least one processor of a computing device cause the computing device to perform acts in accordance with a method of claim 1.

20. A computing device comprising:
a processor;
a network transceiver; and
a computer-readable medium in accordance with claim 19.
